(19) United States
(12) Patent Application Publication
(10) Pub. No.: US 2012/0054237 A1
(43) Pub. Date: Mar. 1, 2012

(54) AUDIENCE MEASUREMENT SYSTEM

(75) Inventors: Avraham Poupko, Jerusalem (IL); Shabtai Atlow, Efrat (IL)

(73) Assignee: NDS Limited, Staines, Middlesex (GB)

(21) Appl. No.: 13/138,817

(22) PCT Filed: Apr. 22, 2009
(86) PCT No.: PCT/IB2009/051657

§ 371 Date: Nov. 14, 2011

(51) Int. Cl. G06F 17/30

(52) U.S. Cl. 707/771; 707/E17.131

(57) ABSTRACT

A method for television viewing data analysis is described comprising, the method including receiving a query including audience parameters defining characteristics of a subset of a viewing audience, and viewing pattern parameters defining viewing patterns to be analyzed, applying the audience parameters to a database of viewer characteristics and determining therefrom a plurality of viewers from whom data is to be collected, building a viewer query based on the viewing pattern parameters, sending the viewer query to a plurality of viewer devices associated with the plurality of viewers for execution thereat, after execution of the viewer query at the plurality of viewer devices, receiving a viewer query result from at least some of the plurality of viewer devices, and analyzing the received viewer query results to produce a result of the query. Related methods and apparatus are also described.

### FIELD OF THE INVENTION

The present invention relates to audience measurement systems.

### BACKGROUND OF THE INVENTION

Audience measurement systems are typically used to rate television viewership of a particular television show in order to determine what prices to charge for advertising during the particular television show.

Certain audience measurement systems are well known in the art. However, well known audience measurement systems typically have certain drawbacks.

For instance, well known audience measurement systems typically depend on a viewer clicking a button on a specialized piece of hardware added to the viewer's television system indicating the viewer's presence in the vicinity of the television. It has been observed that after a period of time during which the viewers are in an audience measurement pool, there is a tendency to become lax in the use of the button to indicate presence. The only way to determine if a particular viewer has watched a particular program (and hence can be counted as part of the appropriate demographic/statistical pool) is if that particular viewer has clicked the appropriate button. Thus, after the period of time when the viewer becomes lax, statistics involving the particular viewer are necessarily suspect.

A second known drawback is that well known audience measurement systems are statically collected, based on predetermined queries. Should a stake-holder want a different analysis of a viewing audience, it is impossible to obtain the desired analysis after the fact.

Another known drawback is that well known audience measurement systems often require up to a week before viewing statistics become available. Aside from the disadvantage of having to wait a week to receive the statistics, should a stakeholder want results in real-time (or as close to real-time as is feasible), using presently available technology, the stakeholder will not receive the desired statistics in the desired timeframe.

Yet another known drawback is that well known audience measurement systems typically require participants to call back and report to a data aggregator at periodic intervals, thereby adding telephone expenses to the data aggregator.

The following patent and patent applications are considered to reflect the current state of the art:

US 20020056086 of Yuen;

US 20050235318 of Grauch, et al;

US 20050278731 of Cameron, et al;

US 20030037333 of Ghashghai, et al;

US 20020133393 of Tatsumi, et al; and

US 20040148625 of Eldering, et al.

### SUMMARY OF THE INVENTION

The present invention, in certain embodiments thereof, seeks to provide an improved

There is thus provided in accordance with an embodiment of the present invention a television viewing data analysis method including receiving a query including audience parameters defining characteristics of a subset of a viewing audience, and viewing pattern parameters defining viewing patterns to be analyzed, applying the audience parameters to a database of viewer characteristics and determining therefrom a plurality of viewers from whom data is to be collected, building a viewer query based on the viewing pattern parameters, sending the viewer query to a plurality of viewer devices associated with the plurality of viewers for execution thereat, after execution of the viewer query at the plurality of viewer devices, receiving a viewer query result from at least some of the plurality of viewer devices, and analyzing the received viewer query results to produce a result of the query.

Further in accordance with an embodiment of the present invention the viewer query includes a prompt for a particular viewer matching a particular demographic is prompted to provide a response.

Still further in accordance with an embodiment of the present invention the particular viewer is offered an incentive to provide the response.

There is also provided in accordance with another embodiment of the present invention a television viewed data analysis method including at a viewer device, receiving a viewer query from a central analysis site, collecting viewer/device behavior data at a data collector, the data including at least one of the following viewer behavior data indicating behavior of a viewer using the device, and device behavior indicating function of the device, applying, at a query processor, the viewer query to the viewer/device behavior data and producing a result, and conditionally reporting the result to the central analysis site.

Further in accordance with an embodiment of the present invention the conditionally reporting includes applying at least one rule to determine at least one of whether and when to report the result.

Still further in accordance with an embodiment of the present invention the rule requires that the result always be reported.

Additionally in accordance with an embodiment of the present invention, the present invention includes prompting at least one viewer to respond by taking an action, a positive response of the at least one viewer being indicative of the viewing presence of the at least one viewer in the proximity of the viewer device.

Moreover in accordance with an embodiment of the present invention the at least one viewer is offered an incentive to reply to the prompting.

There is also provided in accordance with still another embodiment of the present invention a television viewing data analysis method including providing a multiplicity of viewer devices, each viewer device having a call-back time defining a time of day at which the viewer device is to establish communications with a central site and report back data thereto, receiving, at at least some of the multiplicity of viewer devices, an indication that viewer and/or device behavior should be collected for reporting, and at least a portion of the multiplicity of viewer devices reporting information on viewer and/or device behavior to the central site at the call-back time associated with each viewer device.

There is also provided in accordance with still another embodiment of the present invention a television viewing data analysis system including a receiver which receive a query, the query including audience parameters defining characteristics of a subset of a viewing audience, and viewing pattern parameters defining viewing patterns to be analyzed, a processor which applies the audience parameters to a database of viewer characteristics and determine therefrom a plurality of viewers from whom data is to be collected, a viewer query builder which builds a viewer query based on the viewing pattern parameters, a viewer query sender which sends the viewer query to a plurality of viewer devices associated with the plurality of viewers for execution thereat, a viewer query result receiver which, after execution of the viewer query at the plurality of viewer devices, receives a viewer query result from at least some of the plurality of viewer devices, and a second processor which analyzes the received viewer query results to produce a result of the query.

There is also provided in accordance with still another embodiment of the present invention a television viewed data analysis system including a viewer query receiver disposed in a viewer device, which receives a viewer query from a central analysis site, a data collector which collects viewer/device behavior data, the data including at least one of the following viewer behavior data indicating behavior of a viewer using the device, and device behavior indicating function of the device, a query processor which applies, the viewer query to the viewer/device behavior data and produces a result, and a reporter which conditionally reports the result to the central analysis site.

There is also provided in accordance with still another embodiment of the present invention a television viewing data analysis system including a viewer device among a multiplicity of viewer devices, the viewer having a call-back time defining a time of day at which the viewer device is to establish communications with a central site and report back data thereto, a receiver disposed in the viewer device which receives an indication that viewer and/or device behavior should be collected for reporting, and a reporter which reports information on viewer and/or device behavior to the central site at the call-back time associated with the viewer device.

### BRIEF DESCRIPTION OF THE DRAWINGS

The present invention will be understood and appreciated more fully from the following detailed description, taken in conjunction with the drawings in which:

FIG. 1 is a simplified partly pictorial illustration partly block diagram of an audience measurement system constructed and operative in accordance with an embodiment of the present invention;

FIG. 2 is a simplified partly pictorial illustration partly block diagram of one exemplary use of the audience measurement system of FIG. 1;

FIG. 3 is a simplified partly pictorial illustration partly block diagram of one implementation of a viewer device in the system of FIG. 1;

FIG. 4 is a simplified pictorial illustration of one particular embodiment of the audience measurement system of FIG. 1; and

FIGS. 5-7 are simplified flowcharts of preferred methods of operation of the system of FIG. 1.

### DETAILED DESCRIPTION OF AN EMBODIMENT

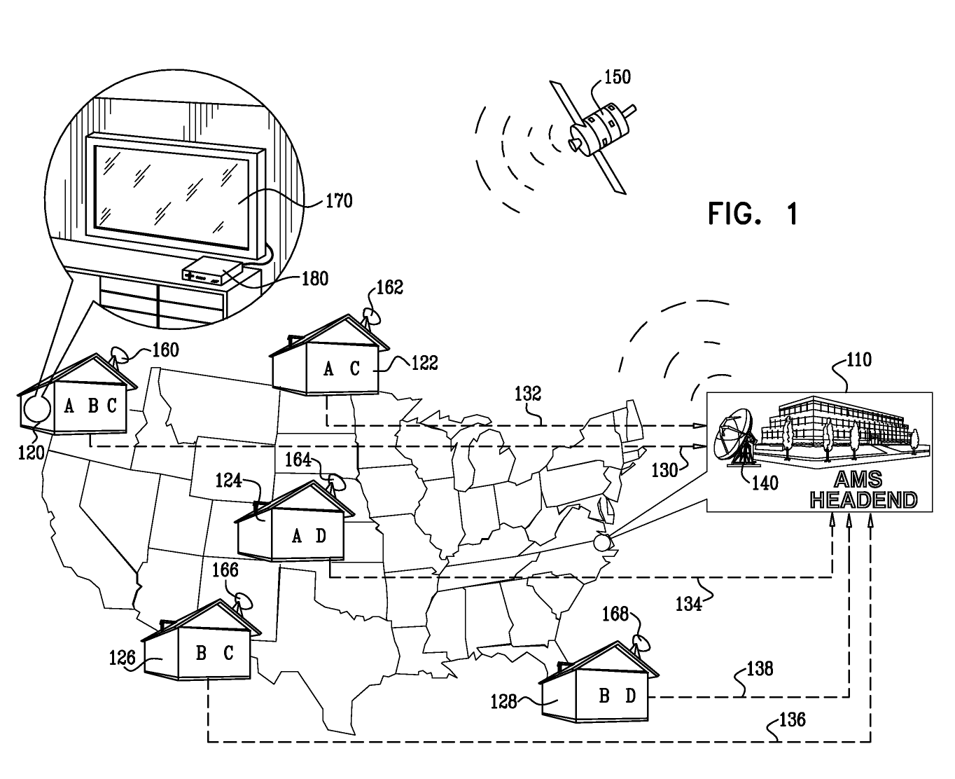

Reference is now made to FIG. 1, which is a simplified partly pictorial illustration partly block diagram of an audience measurement system constructed and operative in accordance with an embodiment of the present invention. The embodiment of the present invention depicted in FIG. 1 comprises an audience measuring system (AMS) head end 110, and an audience. The audience depicted in FIG. 1 comprises at least one member of a multiplicity of households 120, 122, 124, 126, 128 all of which receive a television signal. In addition, each of the multiplicity of households 120, 122, 124, 126, 128 has a communication channel 130, 132, 134, 136, 138 with the AMS head end 110.

Communication between the AMS head end 110 and the multiplicity of households 120, 122, 124, 126, 128 may comprise a two-way communication channel, for example and without limiting the generality of the foregoing, as is found in typical cable television systems. Alternatively, the communication channel may comprise two one-way communication channels, such as, and without limiting the generality of the foregoing, in a satellite television system, the two one-way channels comprising:
a communication channel from the AMS headend 110 to the multiplicity of households 120, 122, 124, 126, 128 comprising an antenna 140 associated with the AMS head end 110, the antenna 140 broadcasting a signal to a satellite 150, and the signal ultimately being received at a satellite dish 160, 162, 164, 166, 168 positioned at each of the multiplicity of households 120, 122, 124, 126, 128; and
a communication channel comprising a telephone or Internet based call back line comprising the communication channel 130, 132, 134, 136, 138 from the multiplicity of households 120, 122, 124, 126, 128 to the AMS head end 110.

In FIG. 1, and throughout the accompanying figures, the communication channel is only depicted as comprising two one-way channels.

Each of the multiplicity of households 120, 122, 124, 126, 128 has apparatus appropriate for viewing television. Those skilled in the art will appreciate that the apparatus may include, but not be limited to a television, a computer monitor, a 3G mobile phone, a display on a hand-held device, a media center, or other appropriate viewing device. It is appreciated that the apparatus appropriate for viewing television may also include such devices as a set top box, a personal video recorder (PVR, also called a digital video recorder, DVR), an Internet enabled DVR, or a computer, said device being connected to the viewing device. For ease of depiction, in FIG. 1 only one household 120 of the multiplicity of households 120, 122, 124, 126, 128 is depicted as comprising a single display device 170 and one viewer device 180 (depicted as a set top box or PVR) associated with and connected to the display device 170.

The multiplicity of households 120, 122, 124, 126, 128 depicted in FIG. 1 are depicted as overlaid on a map of the United States, in order to show that the multiplicity of households 120, 122, 124, 126, 128 may be spread over a very large geographical region.

Each of the multiplicity of households 120, 122, 124, 126, 128 is known to the AMS headend 110 belong to at least one defined demographic group. For example and without limiting the generality of the foregoing, demographic groups may be based, at least in part, on gender, occupation, age, geographic location of household, mean income, and so forth. In FIG. 1, household 120 is depicted as belonging to demographic groups A, B, and C. Household 122 is depicted as belonging to demographic groups A and C. Household 124 is depicted as belonging to demographic groups A and D. Household 126 is depicted as belonging to demographic groups B and C. Household 128 is depicted as belonging to demographic groups B and D.

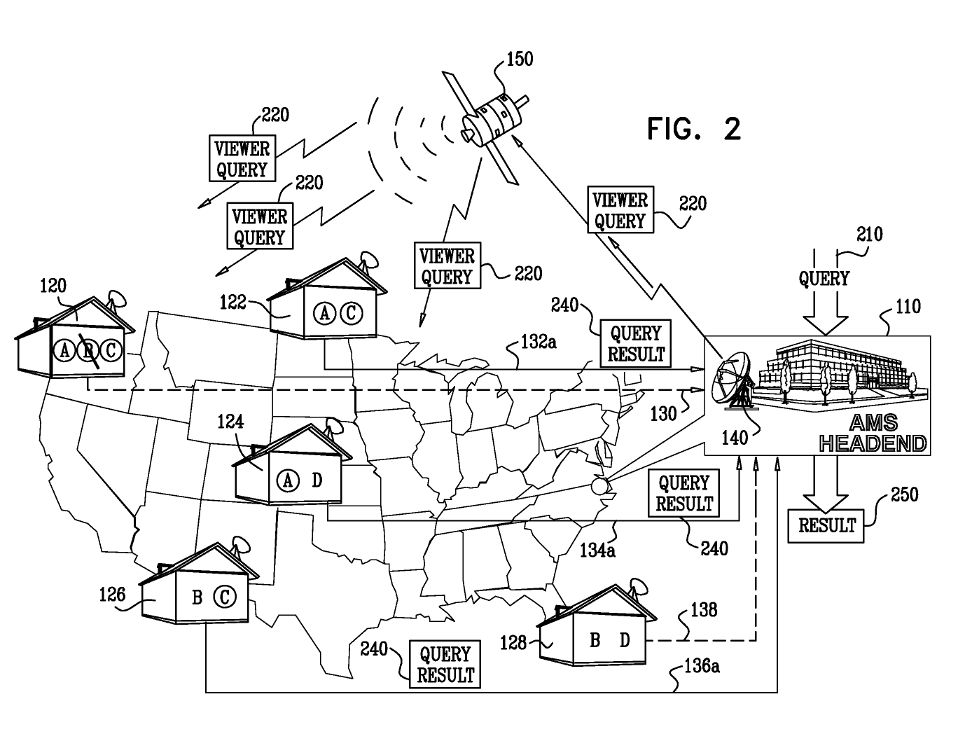

Reference is now made to FIG. 2, which is a simplified partly pictorial illustration partly block diagram of one exemplary use of the audience measurement system of FIG. 1. In the embodiment depicted in FIG. 2, the AMS headend 110 receives a query 210. The query may be received by the AMS headend 110 from a broadcaster (not depicted), a content owner (not depicted), a network owner (not depicted), an advertiser (not depicted), or another interested party. The query 210 includes, but is not necessarily limited to: audience parameters defining characteristics of a subset of a viewing audience; and viewing pattern parameters defining viewing patterns to be analyzed.

The AMS headend 110 applies the audience parameters to a database of viewer characteristics and determines therefrom a plurality of viewers from whom data is to be collected. For example and without limiting the generality of the foregoing, if the query 210 is to analyze a certain viewing pattern in any household fitting into viewer characteristics of either demographic group A or demographic group C, but not demographic group A and demographic group B together, then:
the household depicted as household 120 being in all of demographic group A, demographic group B, and demographic group C, is excluded from the plurality of viewers from whom data is to be collected, since demographic groups A and B together are excluded;
the household depicted as household 122, being in both demographic group A and demographic group C, and is included in the plurality of viewers from whom data is to be collected;
the household depicted as household 124, being in demographic group A is included in the plurality of viewers from whom data is to be collected (demographic group D, of which household 124 is a member, is irrelevant for the query 210);
the household depicted as household 126, being in demographic group C is included in the plurality of viewers from whom data is to be collected (demographic group B (in the absence of demographic group A), of which household 124 is a member, is irrelevant for the query 210); and
the household depicted as household 128, being included in neither demographic group A nor demographic group C, is excluded from the plurality of viewers from whom data is to be collected (demographic groups B and D, both of which household 124 is a member, are irrelevant for the query 210).

Once the plurality of viewers from whom data is to be collected is determined (in the present example, households 122, 124, and 126), the AMS headend 110 builds a viewer query 220 based on the viewing pattern parameters (the viewing pattern parameters having been received in the query 210). The AMS headend 110 then sends the viewer query 220 to a plurality of viewer devices 180 (FIG. 1) associated with the plurality of viewers for execution thereat. In the present example, the viewer query 220 is broadcast to households 122, 124, and 126. It is appreciated that in different environments, rather than broadcasting the viewer query 220, the viewer query 220 may be multicast only to groups of viewers in the plurality of viewers from whom data is to be collected, or possibly even unicast to particular viewers in the plurality of viewers from whom data is to be collected.

It is appreciated that the viewer query 220 is depicted and described as originating at the AMS headend 110. In fact, the viewer query 220 may originate at any appropriate central analysis site.

Each targeted viewer device 180 (FIG. 1) receives the viewer query 220. The viewer query 220 is then executed at each viewer device 180 (in the present example, at the viewer device 180 in each of households 122, 124, 126). After the viewer device 180 in each of households 122, 124, and 126 executes the viewer query 220, the viewer device 180 in each of households 122, 124, and 126 returns a query result 240 to the AMS headend 110. The query result 240 comprises a result of the viewer query 220 for each of the multiplicity of households 120, 122, 124, 126, 128. (It is appreciated that in the present example the result of the viewer query 220 for household 120 and household 128 is null, as neither household 120 nor household 128 is included in the viewer query 220.)

The AMS headend 110 is then able to analyze the received viewer query results in order to produce a result 250 of the query 210.

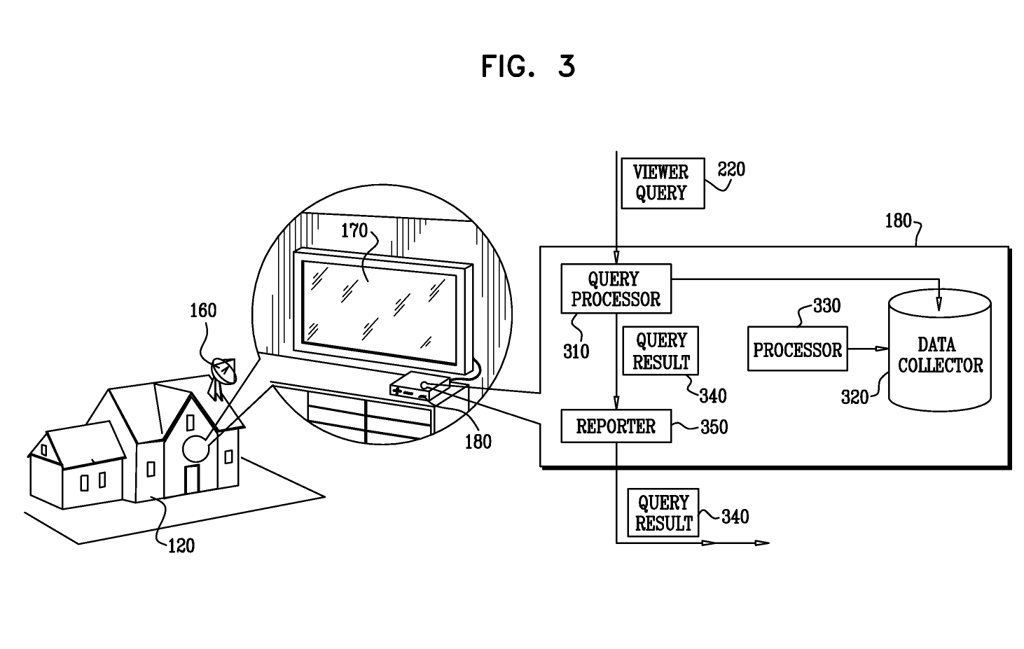

Reference is now made to FIG. 3, which is a simplified partly pictorial illustration partly block diagram of one implementation of the viewer device 180 in the system of FIG. 1. FIG. 3 depicts one household 120 of the multiplicity of households 120, 122, 124, 126, 128 depicted in FIG. 1. The viewer device 180 is depicted as a set top box or PVR associated with the display device 170.

The viewer device 180 is preferably implemented in an appropriate combination of hardware and/or software, as is known in the art. The operation of the viewer device 180 in the system of FIG. 1 is now described. As was described above with reference to in FIG. 2, the viewer device 180 receives the viewer query 220. The received viewer query 220 is forwarded to a query processor 310.

The query processor 310 receives the viewer query 220 and applies the viewer query 220 to data located in a data collector 320. A second processor 330 typically runs in the viewer device 180 and, in a near real-time fashion, stores data which may be of interest to the AMS headend 110 (FIG. 1) in the data collector 320. Typically, such information which may be stored by the data collector 320 stores includes, but is not limited to:
viewer behavior data indicating behavior of a viewer using the viewer device 180; and
device behavior indicating function of the viewer device 180.

The data collector 320 sends a query result 340 of the viewer query 220 to the data located in a data collector 320 to a reporter 350. The reporter 350 conditionally reports the query result 340 to the AMS headend 110 (FIG. 1). It is appreciated that the conditionally reporting comprises applying at least one rule to determine at least one of whether, under what circumstances, and at what time to report the result. For example and without limiting the generality of the foregoing, under certain conditions, reporting of the query result 340 by the reporter 350 to the AMS headend 110 (FIG. 1) may be random, that is to say, some viewer devices 180 may report the query result 340, and some other viewer devices 180 may not report the query result 340. It is further appreciated that in some cases the rule requires that the query result 340 always be reported. Alternatively, some other behaviors, such as future viewing may determine if the query result 340 is reported or not. For example and without limiting the generality of the foregoing, watching a sporting event after more than 30 seconds of channel zapping may trigger reporting the query result 340.

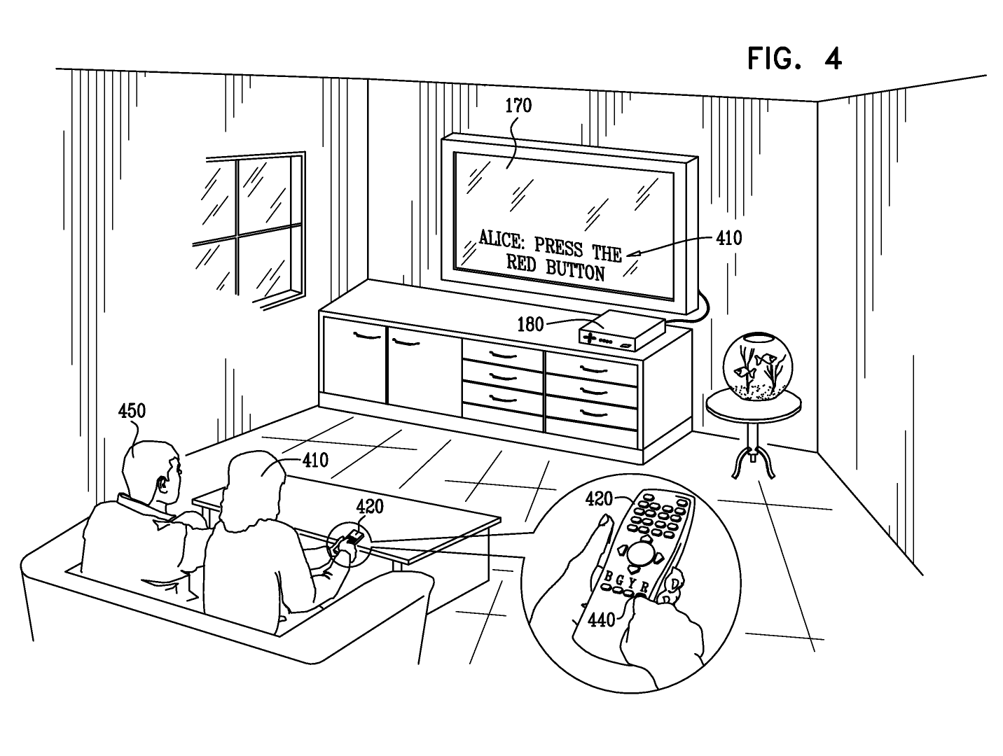

Reference is now made to FIG. 4, which is a simplified pictorial illustration of one particular embodiment of the audience measurement system of FIG. 1. In the embodiment of the present invention depicted in FIG. 4, the viewer device 180 receives a query which is dependent on a presence of a certain member of the household 120 (FIGS. 1-3). In order to determine if the certain member of the household is indeed present or not, the viewer device 180 causes the display device 170 to present an on-screen display (OSD) 410, as is known in the art. In the example depicted in FIG. 4, the OSD prompts Alice 415, a member of the household 120 (FIGS. 1-3) to “Press the Red Button”. Alice 415, in response to the prompting by the OSD 410, is depicted as pressing the red button 440 on a remote control 420. Pressing the red button 440 comprises a positive response from Alice to the OSD 410, and indicates presence of the certain member of the household 120 (Alice 415, in the present example) in the proximity of the viewer device 180.

Bob 450, also physically present, but not prompted by the OSD 410 to press the red button 440 on the remote control 420, does not press the red button 440 on the remote control 420.

It is appreciated that, in order to create further incentive for the targeted user to press the red button, an incentive system may be in place. For instance, and without limiting the generality of the foregoing, Alice 415 could be awarded a certain number of points towards winning a prize as a reward for pressing the red button.

Referring back additionally to FIG. 2, in order to further illustrate the embodiment of the audience measurement system depicted in FIG. 4, the following example is provided. If the query 210 is directed to determine if female bankers (for instance, Alice 415) living on the West Coast of the United States are viewing, at a given moment, a particular television program, then the viewer query 220 would be addressed to households located on the West Coast of the United States in female bankers are resident, such as household 120. In order to determine if Alice 415, a female banker is watching the television at this moment, Alice 415 is prompted, in the OSD 410, to press the red button 440 on the remote control 420. As was noted above, reporting back by the viewer device 180 may follow a rule. In the present example, the rule may be to report back from all households in which a female banker responds to the prompt. Alternatively only half of the households in which a female banker responds to the prompt may be required to report back, in order to save bandwidth. The AMS headend 110 would then double the results reported back.

Once the viewer device 180 receives a response from Alice 415, or, if need be, in the absence of a response from Alice 415 within a certain amount of time, the viewer device 180 utilizes the communication channel 130 (in the case of household 120) with the AMS headend 110 in order to send the query result 340 (FIG. 3) to the AMS headend 110. For instance, the query result may indicate one of: Alice 415 was not present; although Alice 415 was present, Alice 415 was not viewing the particular television program; and Alice was present and viewing the particular television program.

In an alternative embodiment of the present invention, each of a multiplicity of viewer devices (such as the viewer device 180, depicted in FIGS. 1-4) is provided with a call-back time. The call-back time provided to each of the multiplicity of viewer devices defines a time of day at which the viewer device is to establish communications with a central site and report back data thereto, as is known in the art. Those skilled in the art will appreciate that the central site may comprise the AMS headend 110, or other appropriate site.

From time to time, at at least some of the multiplicity of viewer devices, an indication is received that viewer and/or device behavior should be collected for reporting to the central site. For example and without limiting the generality of the foregoing, at least some of the viewer devices may receive or be targeted by the viewer query 220. The behavior of the viewer devices which receive or are targeted by the viewer query 220, in response to the viewer query is described above.

At least a portion of the multiplicity of viewer devices then report information (for instance the result 340) comprising at least one of: viewer behavior related information; and device behavior related information to the central site at the call-back time associated with each viewer device.

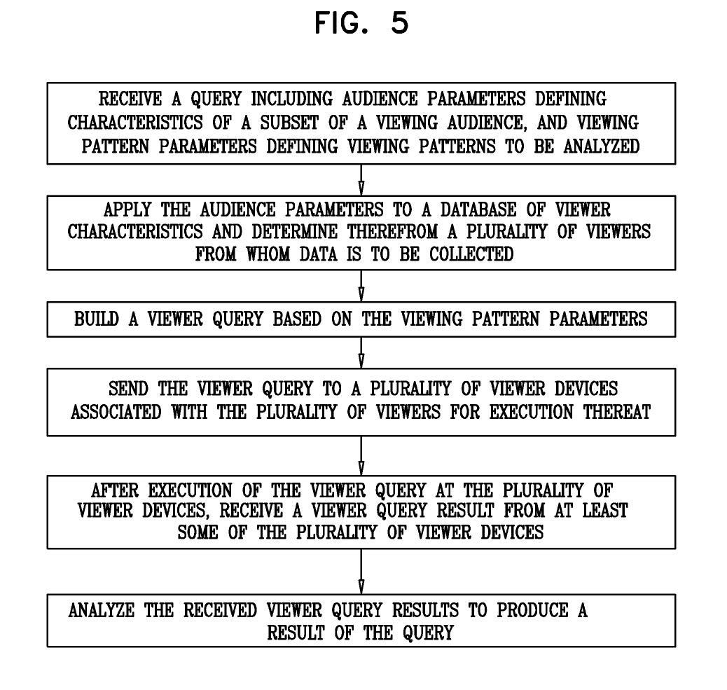

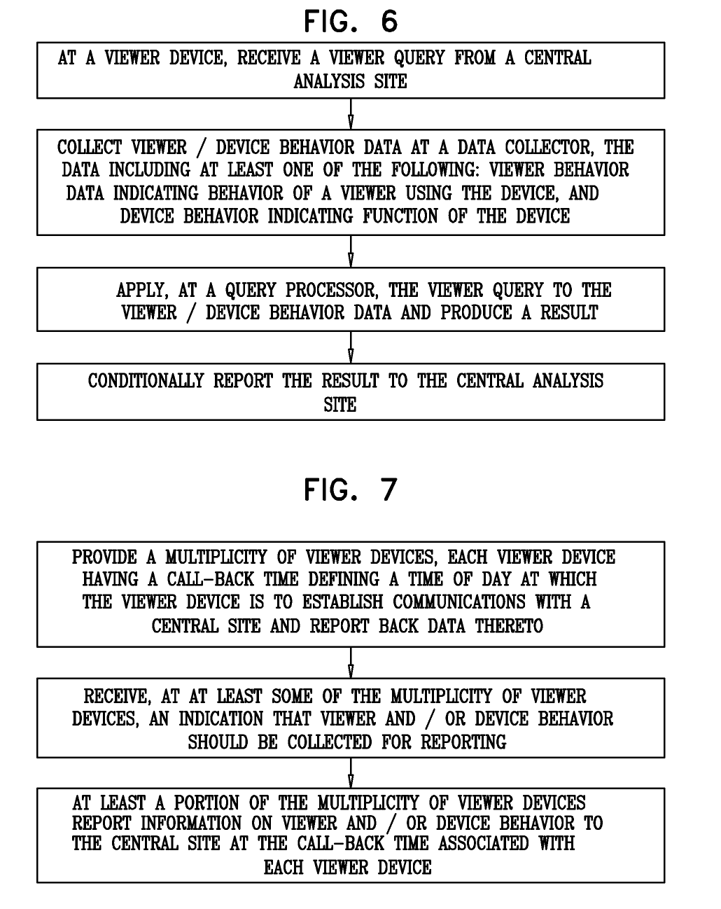

Reference is now made to FIGS. 5-7, which are simplified flowcharts of preferred methods of operation of the system of FIG. 1. FIGS. 5-7 are believed to be self-explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

1. A television viewing data analysis method comprising:
receiving a query including: audience parameters defining characteristics of a subset of a viewing audience; and viewing pattern parameters defining viewing patterns to be analyzed;
applying the audience parameters to a database of viewer characteristics and determining therefrom a plurality of viewers from whom data is to be collected;
building a viewer query based on the viewing pattern parameters;
sending the viewer query to a plurality of viewer devices associated with the plurality of viewers for execution thereat;
after execution of the viewer query at the plurality of viewer devices, receiving a viewer query result from at least some of the plurality of viewer devices; and
analyzing the received viewer query results to produce a result of the query.

2. The method according to claim 1 and wherein the viewer query comprises a prompt for a particular viewer matching a particular demographic is prompted to provide a response.

3. The method according to claim 2 and wherein the particular viewer is offered an incentive to provide the response.

4. A television viewed data analysis method comprising:
at a viewer device, receiving a viewer query from a central analysis site;
collecting viewer/device behavior data at a data collector, the data including at least one of the following:
viewer behavior data indicating behavior of a viewer using the device; and
device behavior indicating function of the device;
applying, at a query processor, the viewer query to the viewer/device behavior data and producing a result; and
conditionally reporting the result to the central analysis site.

5. The method according to claim 4 and wherein the conditionally reporting comprises:
applying at least one rule to determine at least one of whether and when to report the result.

6. The method according to claim 5 and wherein the rule requires that the result always be reported.

7. The method according to claim 4 and further comprising prompting at least one viewer to respond by taking an action, a positive response of the at least one viewer being indicative of the viewing presence of the at least one viewer in the proximity of the viewer device.

8. The method according to claim 7 and wherein the at least one viewer is offered an incentive to reply to the prompting.

9. A television viewing data analysis method comprising:
providing a multiplicity of viewer devices, each viewer device having a call-back time defining a time of day at which the viewer device is to establish communications with a central site and report back data thereto;
receiving, at at least some of the multiplicity of viewer devices, an indication that viewer and/or device behavior should be collected for reporting; and
at least a portion of the multiplicity of viewer devices reporting information on viewer and/or device behavior to the central site at the call-back time associated with each viewer device.

10. A television viewing data analysis system comprising:
a receiver which receive a query, the query including: audience parameters defining characteristics of a subset of a viewing audience; and viewing pattern parameters defining viewing patterns to be analyzed;
a processor which applies the audience parameters to a database of viewer characteristics and determine therefrom a plurality of viewers from whom data is to be collected;
a viewer query builder which builds a viewer query based on the viewing pattern parameters;
a viewer query sender which sends the viewer query to a plurality of viewer devices associated with the plurality of viewers for execution thereat;
a viewer query result receiver which, after execution of the viewer query at the plurality of viewer devices, receives a viewer query result from at least some of the plurality of viewer devices; and
a second processor which analyzes the received viewer query results to produce a result of the query.

11. A television viewed data analysis system comprising:
a viewer query receiver disposed in a viewer device, which receives a viewer query from a central analysis site;
a data collector which collects viewer/device behavior data, the data including at least one of the following:
viewer behavior data indicating behavior of a viewer using the device; and
device behavior indicating function of the device;
a query processor which applies, the viewer query to the viewer/device behavior data and produces a result; and
a reporter which conditionally reports the result to the central analysis site.

12. A television viewing data analysis system comprising:
a viewer device among a multiplicity of viewer devices, the viewer having a call-back time defining a time of day at which the viewer device is to establish communications with a central site and report back data thereto;
a receiver disposed in the viewer device which receives an indication that viewer and/or device behavior should be collected for reporting; and
a reporter which reports information on viewer and/or device behavior to the central site at the call-back time associated with the viewer device.
